(19) United States
(12) Patent Application Publication
(10) Pub. No.: US 2010/0103353 A1
(43) Pub. Date: Apr. 29, 2010

(54) CONNECTION COMBINATION TYPE OPTICAL FILM, LIQUID CRYSTAL PANEL, IMAGE DISPLAY DEVICE, AND LIQUID CRYSTAL DISPLAY DEVICE

(75) Inventor: Taku Yamada, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/518,183

(22) PCT Filed: Jan. 21, 2008
(86) PCT No.: PCT/JP2008/050720

§ 371 Date: Jun. 8, 2009

(30) Foreign Application Priority Data
Jan. 31, 2007 (JP) 2007-020637
Oct. 9, 2007 (JP) 2007-263362

(51) Int. Cl. G02F 1/1335; G02B 27/00; G02F 1/1333

(52) U.S. Cl. 349/96; 359/507; 349/122

(57) ABSTRACT

An object of the invention is to prevent light leakage over time in a combined optical film including a plurality of optical films whose end faces are allowed to abut against each other. The invention is directed to a combined optical film, including: a plurality of optical films each having at least one end face, wherein the end faces abut against each other; and a transparent connection film that is adhered to at least one side of each of the optical films through a pressure-sensitive adhesive layer or an adhesive layer so that the optical films are joined by the transparent connection film.

### TECHNICAL FIELD

The invention relates to a combined optical film including a plurality of optical films whose end faces are allowed to abut against each other. The invention also relates to an image display such as a liquid crystal display, an organic electroluminescence (EL) display and a plasma display panel (PDP), using the combined optical film.

Examples of the optical film include a polarizer and a polarizing plate including a polarizer and a protective film placed on one or both sides of the polarizer. Examples of the optical film other than the polarizer and the polarizing plate include a retardation plate, an optical compensation film, and a brightness enhancement film. One or more of these films may be used alone or in combination.

### BACKGROUND ART

Image displays such as liquid crystal displays for use in televisions, personal computers or the like use optical films such as polarizing plates. As the size of televisions or the like has grown in recent years, large-area optical films have been demanded. For the manufacture of large-area optical films, corresponding large manufacturing facilities are necessary. In order to install such large manufacturing facilities, a large place is also required. Therefore, there has been proposed a technology that includes arranging a plurality of liquid crystal displays with their end faces abutting against one another to form a large-sized liquid crystal display.

Liquid crystal displays of televisions, personal computers or the like produce a display by transmitting and blocking (absorbing) light from their back side based on the function of optical films such as polarizing plates. Therefore, the portion of the end faces of liquid crystal displays butted against one another has a problem in which light can leak from the portion to from a light line on the front face of the liquid crystal displays. For this problem, it is proposed that the shape of the end faces of the optical films butted against one another should be designed to prevent light leakage from the combined optical film (see Patent Document 1). Such a combined optical film can prevent light leakage without degrading appearance. Patent Document 1: Japanese Patent Application Laid-Open (JP-A) No. 2006-163377

### DISCLOSURE OF INVENTION

### Problems to be Solved by the Invention

However, even the combined optical film mentioned above can cause light leakage, because a gap is formed between the end faces during use of it in a liquid crystal display or the like.

An object of the invention is to prevent light leakage over time in a combined optical film including a plurality of optical films whose end faces are allowed to abut against each other.

Another object of the invention is to provide a liquid crystal panel using such a combined optical film and to provide a liquid crystal display using such a liquid crystal panel. A further object of the invention is to provide an image display using such a combined optical film.

### Means for Solving the Problems

As a result of investigations to solve the problems, the inventors have found that the combined optical film and other technologies described below satisfy the objects set forth above, and have completed the invention.

Specifically, the invention is directed to a combined optical film, including: a plurality of optical films each having at least one end face, wherein the end faces abut against each other; and a transparent connection film that is adhered to at least one side of each of the optical films through a pressure-sensitive adhesive layer or an adhesive layer so that the optical films are joined by the transparent connection film.

In the combined optical film, the optical film used preferably includes a polarizer or a polarizing plate including a polarizer and a transparent protective film placed on one or both sides of the polarizer.

In the combined optical film, the transparent connection film on at least one side is preferably made of a thermoplastic resin with a water-vapor permeability of 100 g/m² per 24 hours or less.

The invention is also directed to a liquid crystal panel including a liquid crystal cell and the combined optical film placed on at least one side of the liquid crystal cell.

In the liquid crystal panel, the optical film used in the combined optical film preferably includes a polarizer or a polarizing plate including a polarizer and a transparent protective film placed on one or both sides of the polarizer.

In the liquid crystal panel, the combined optical film used is preferably placed on the backlight side of the liquid crystal cell. In addition, the combined optical film is preferably placed on the backlight side of the liquid crystal cell in such a manner that the transparent connection film on at least one side is placed on the backlight side. The transparent connection film placed on the backlight side is preferably made of a thermoplastic resin with a water-vapor permeability of 100 g/m² per 24 hours or less.

The invention is also directed to an image display device having the combined optical film.

The invention is also directed to a liquid crystal display device having the liquid crystal panel.

### EFFECT OF THE INVENTION

In the combined optical film of the invention, a plurality of optical films abut against each other and are combined with a transparent connection film to which at least one side of the optical films combined is adhered through a pressure-sensitive adhesive layer or an adhesive layer. The combination optical films are joined by the transparent connection film. In the resulting combined optical film, the transparent connection film prevents the gap between the end faces of the optical films from widening over time so that an increase in light leakage over time can be prevented.

The combined optical film of the invention may be placed on the upper side (viewer side) of a liquid crystal cell and/or the lower side (backlight side) of a liquid crystal cell in a liquid crystal display device. The placement on the lower side (backlight side) is preferred, because the end faces of the optical films on the lower side are relatively hard to see.

In a liquid crystal display device, polarizing plates (or polarizers), which are optical films, are placed on the upper side and the lower side of a liquid crystal cell in such a manner that their absorption axes are orthogonal to each other. The polarizing plate (or polarizer) placed on the lower side is close to a backlight and therefore relatively easily undergoes shrinkage or deformation due to the heat from a backlight, which means that the gap between the polarizing plates can become wider over time on the lower side than on the upper side. Therefore, the combined optical film is required to have thermal durability. Concerning such durability, the combined optical film may be placed on the lower side of a liquid crystal cell in such a manner that the transparent connection film is placed on the backlight side so that the durability can be improved. In addition, the transparent connection film placed on the backlight side may be made of a thermoplastic resin with a water-vapor permeability of 100 g/m² per 24 hours or less so that the durability can be further improved.

In a more preferred embodiment of the invention, the combined optical film includes: a plurality of polarizing plates each having at least one end face and including a polarizer and a transparent protective film placed on one or both sides of the polarizer, wherein the end faces abut against each other; and a transparent connection film that is adhered to at least one side of each of the polarizing plates through a pressure-sensitive adhesive layer or an adhesive layer so that the polarizing plates are joined by the transparent connection film. This structure is characterized by including the polarizing plates as the optical films. Preferably, the polarizing plates is less likely to undergo dimensional change over time than the polarizer alone so that the gap between the end faces abutting against each other can be less likely to become wider over time. In addition, the polarizing plate including the polarizer and the transparent protective films placed on both side of the polarizer is preferred, because it has higher mechanical strength and is less likely to undergo dimensional change over time than the polarizing plate including the polarizer and the transparent protective film placed on one side of the polarizer.

In a more preferred embodiment, the combined optical film includes: a plurality of polarizing plates each having at least one end face and including a polarizer and a transparent protective film placed on one or both sides of the polarizer, wherein the end faces abut against each other; and a transparent connection film that is adhered to at least one side of each of the polarizing plates through a pressure-sensitive adhesive layer so that the polarizing plates are joined by the transparent connection film. This structure is characterized by including the polarizing plates as the optical films and including the pressure-sensitive adhesive layer with which the transparent connection film is adhered. Preferably, the polarizing plates is less likely to undergo dimensional change over time than the polarizer alone so that the gap between the end faces abutting against each other can be less likely to become wider over time. Preferably, the pressure-sensitive adhesive can have a lower viscosity than that of the adhesive so that it can be less likely to intrude or cannot intrude into the gap between the end faces abutting against each other than the adhesive. In addition, the polarizing plate including the polarizer and the transparent protective films placed on both side of the polarizer is preferred, because it has higher mechanical strength and is less likely to undergo dimensional change over time than the polarizing plate including the polarizer and the transparent protective film placed on one side of the polarizer. In view of durability over time during use, therefore, it is particularly preferred to use the polarizing plate including the polarizer and the transparent protective films placed on both sides of the polarizer and to use the pressure-sensitive adhesive which is less likely to intrude into the gap between the end faces abutting against each other than the adhesive.

### BRIEF DESCRIPTION OF DRAWINGS

FIG. 1 is a cross-sectional view showing an example of the combined optical film of the invention;

FIG. 2 is a cross-sectional view showing another example of the combined optical film of the invention;

FIG. 3 is a cross-sectional view showing a further example of the combined optical film of the invention;

FIG. 4 is a cross-sectional view showing a further example of the combined optical film of the invention;

FIG. 5 is a cross-sectional view showing an example of the liquid crystal display device using the combined optical film of the invention;

FIG. 6 is a cross-sectional view showing another example of the liquid crystal display device using the combined optical film of the invention; and

FIG. 7 is a cross-sectional view showing an example of the liquid crystal display device using a conventional combined optical film.

### DESCRIPTION OF REFERENCE SYMBOLS

A an optical film
P a polarizing plate
B a transparent connection film
X end faces abutting against each other
C a pressure-sensitive adhesive layer or an adhesive layer
R a combined optical film
LC a liquid crystal cell
BL a backlight

### BEST MODE FOR CARRYING OUT THE INVENTION

The combined optical film of the invention and the liquid crystal panel therewith are described below with reference to the drawings.

In producing the combined optical film of the invention, the sizes of the optical films to be combined are each adjusted according to the size of the combined optical film to be produced. Any number of pieces of optical films may be combined. While the combined optical film to be produced may be of any size, large size products with sizes of 65 inches or more (or 800 mm or more in length and 1350 mm or more in width) are effectively produced. Even when small combined optical films are produced, for example, residual parts which have ever been discarded as being odd-sized can be effectively combined and reused.

FIGS. 1 to 4 each illustrate the cross-section of a combined optical film R including: a plurality of optical films A each having at least one end face x, wherein the end faces x abut against each other; and a transparent connection film B that is adhered to at least one side of each of the optical films A through a pressure-sensitive adhesive layer (or an adhesive layer) C each of the films A and the film B so that the optical films A are joined by the transparent connection film B. FIGS. 1 to 4 each show a case where two optical films A are combined. The front and back sides of each optical film are interchangeable, and any one side may be its front or back side.

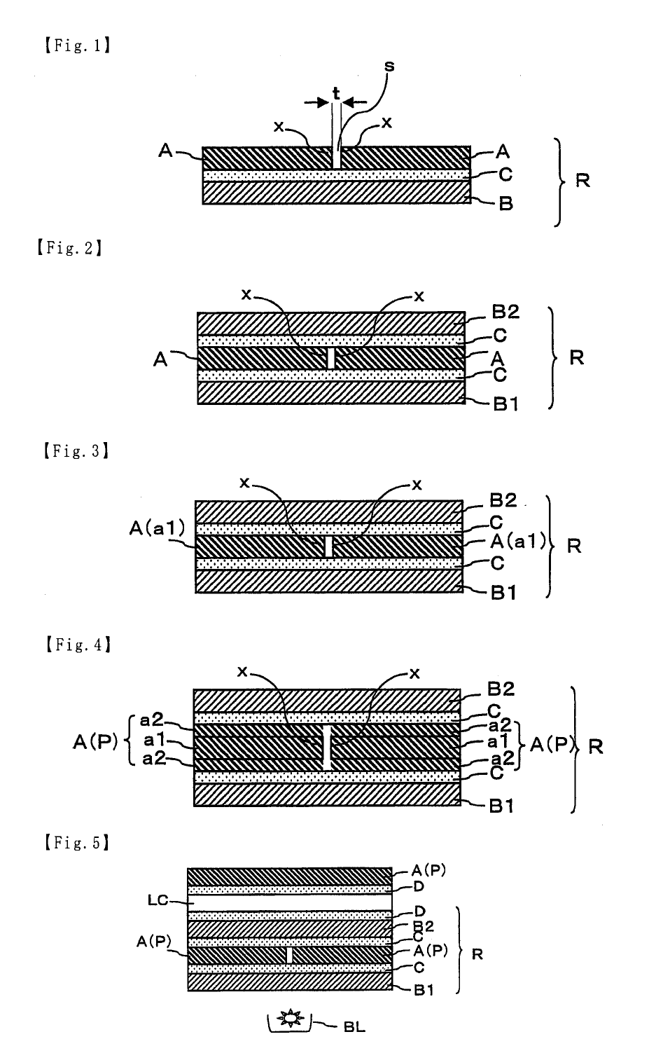

FIGS. 1 to 4 each illustrate a case where a gap s with a width of t is provided between the end faces of the optical films A abutting against each other. As used herein, the width t refers to the maximum width of the gap s. In each of FIGS. 2 to 4, the symbols t for the width and s for the gap are omitted.

In the combined optical film shown in each of FIGS. 1 to 4, the end faces x abutting against each other are substantially perpendicular to the front and back surfaces of the optical films A, while the end faces x abutting against each other are not limited to such a mode in the combined optical film. Alternatively, the end faces x abutting against each other may be in the form of planes inclined between the front and back surfaces of the optical films A. The end face may also have any other shape. In general, the width t of the gap s between the end faces x abutting against each other is preferably 15 μm or less, and it is desired that no gap be provided therebetween. In order to eliminate the gap, the end faces x to be butted against each other should preferably be worked with a high degree of precision by cutting, polishing, or any other method.

In general, the same optical films A are used and combined. A pair of optical films A shown on the left and right of each drawing are preferably the same.

The optical film A may be of any of various types. FIGS. 1 and 2 each show a case where the optical film A used is a single layer. The optical film A to be used may be a single layer or a laminate of two or more layers. The optical films A to be combined may be of the same type or of different types. Two or more layers may be laminated with an adhesive or a pressure-sensitive adhesive to form the optical film A. FIG. 3 shows a case where a polarizer a1 is used as the optical film A. FIG. 4 shows a case where a polarizing plate (P) that includes a polarizer a1 and transparent protective films a2 placed on both sides of the polarizer a1 is used as the optical film A. An adhesive (not shown in FIG. 4) is used to laminate the polarizer a1 and the transparent protective films a2. Besides the above, examples of the optical film A include a retardation plate, an optical compensation film, and a brightness enhancement film. The same may apply to the optical film A shown in any other drawing.

In each of FIGS. 1 to 4, the gap s is provided between the end faces x abutting against each other. The end faces x abutting against each other may be adhered together with an adhesive. The adhesive to be used may be a generally known adhesive or pressure-sensitive adhesive. The adhesive preferably has a refractive index substantially the same as that of the optical film A. Alternatively, the end faces x abutting against each other may be adhered together by dissolving the optical films A with an organic solvent and then solidifying them. The end faces x abutting against each other may also be adhered together by heat sealing.

In the combined optical film R of FIG. 1, the transparent connection film B is adhered to one side of the combined optical films. The transparent connection film B is adhered with C which is the pressure-sensitive adhesive layer or adhesive layer. In each of FIGS. 2 to 4, transparent connection films B1 and B2 are adhered to both sides of the combined optical films. The transparent connection films B1 and B2 may be made of the same material or different materials and may have the same properties or different properties. An adhesive layer C is used in the case of the optical film A (polarizer) of FIG. 3. A pressure-sensitive adhesive layer C is used in the case of the optical film A (polarizing plate) of FIG. 4. In the case of the optical film A of FIG. 3 or 4, the transparent connection films B1 and B2 are adhered to both sides of the combined optical films. Alternatively, the transparent connection film B1 or B2 may be adhered to only one side as shown in FIG. 1.

Although not shown, an easily-peelable protective film may be attached to the front and back surfaces of the combined optical film R. For example, one side (the front surface) may be covered with an easily-peelable protective film L1 (a laminate of a base film and an easily-peelable pressure-sensitive adhesive layer), while the other side (back surface) may be covered with a laminate of a pressure-sensitive adhesive layer D to be adhered to any other member and an easily-peelable protective film L2 (separator) for the pressure-sensitive adhesive layer D. The easily-peelable protective film (separator) L2 is separated and removed from the adhesive interface with the pressure-sensitive adhesive layer D. On the other hand, the protective film L1 is generally a laminate of a base film and an easily-peelable pressure-sensitive adhesive layer, and the base film is separated and removed together with the pressure-sensitive adhesive layer.

FIGS. 1 to 4 each illustrate a case where two optical films A are used to form a combined optical film R. Alternatively, two optical films A may be combined lengthwise and transversely (four optical films A in total).

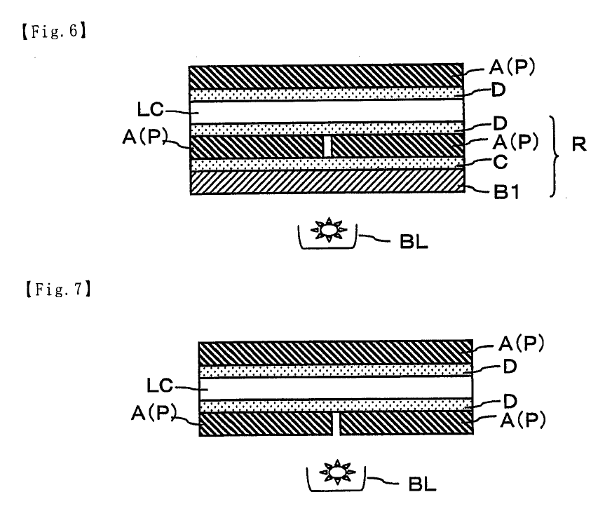

FIGS. 5 and 6 are cross-sectional views each showing a liquid crystal panel that includes a liquid crystal cell LC and the combined optical film R adhered to the lower side (backlight side) of the liquid crystal cell LC through a pressure-sensitive adhesive layer D. In each of FIGS. 5 and 6, the combined optical film R used is a combined polarizing plate R as shown in FIG. 4 in which each optical film A is a polarizing plate P. A common polarizing plate P is adhered to the upper side (viewer side) of the liquid crystal cell LC through a pressure-sensitive adhesive layer D.

FIG. 6 illustrates a case where a transparent connection film B1 is provided on only one side in the combined optical film R of FIG. 4 adhered through the pressure-sensitive adhesive layer D. When a transparent connection film B1 is provided on only one side, the transparent connection film B1 is preferably placed on the backlight BL side as shown in FIG. 6.

The transparent connection film B1 placed on the backlight BL side in the combined optical film R as shown in FIG. 5 or 6 is preferably made of a thermoplastic resin with a water-vapor permeability of 100 g/m² per 24 hours or less as described above. FIG. 7 is a cross-sectional view of a liquid crystal panel including a liquid crystal cell LC and a combined optical film (polarizing plate) adhered to the lower side (backlight side) of the liquid crystal cell LC through a pressure-sensitive adhesive layer D, wherein the combined optical film has no transparent connection film B adhered therein.

A description is given below of the optical films A used to form the combined optical film R of the invention.

Any type of optical films that have been used to form image display devices such as liquid crystal display devices may be used as the optical films A. For example, the optical film A may be a polarizing plate P. The polarizing plate generally used includes a polarizer a1 and a transparent protective film a2 provided on one or both sides of the polarizer a1. The polarizer a1 may also be used independently as the optical film A.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. In these, a polyvinyl alcohol type film on which dichromatic materials such as iodine, is absorbed and aligned after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate or zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

The transparent protective film provided on one or both sides of the polarizer may be made of a thermoplastic resin with a high level of transparency, mechanical strength, thermal stability, moisture blocking properties, isotropy, or the like. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic polyolefin polymer resins (norbornene-based resins), polyarylate resins, polystyrene resins, polyvinyl alcohol resins, and any mixtures thereof. The polarizer and the transparent protective film are generally adhered together with an adhesive layer. Thermosetting resins or ultraviolet-ray curing-type resins such as (meth)acrylic, urethane-based, acrylic urethane-based, epoxy-based, or silicone-based resins may be used for the transparent protective film. The transparent protective film may also contain at least one type of any appropriate additive. Examples of such an additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, even more preferably from 60 to 98% by weight, in particular, preferably from 70 to 97% by weight. If the content of the thermoplastic resin in the transparent protective film is 50% by weight or less, high transparency and other properties inherent in the thermoplastic resin may be insufficiently exhibited.

The transparent protective film may also be a polymer film as disclosed in JP-A No. 2001-343529 (WO01/37007), such as a resin composition including: (A) a thermoplastic resin having a substituted and/or unsubstituted imide group in the side chain; and (B) a thermoplastic resin having a substituted and/or unsubstituted phenyl and nitrile groups in the side chain. Examples thereof include films of a resin composition containing an isobutylene-N-methylmaleimide alternating copolymer and an acrylonitrile-styrene copolymer. The film may be a product formed by mixing and extruding the resin composition. These films have relatively low retardation and relatively low photoelastic coefficient so that they can cancel defects such as unevenness due to distortion of the polarizing plate. These films also have low water-vapor permeability and thus high durability to moisture.

The thickness of the transparent protective film may be determined as appropriate. In view of strength, workability such as handleability, thin layer properties and so on, the thickness of the transparent protective film is generally from about 1 to about 500 μm, particularly preferably from 1 to 300 μm, more preferably from 5 to 200 μm. The transparent protective film with a thickness of 5 to 150 μm is particularly suitable.

When a transparent protective film is provided on both sides of the polarizer, transparent protective films made of the same polymer material or different polymer materials may be used on the front and back sides, respectively.

At least one selected from a cellulose resin, a polycarbonate resin, a cyclic polyolefin resin, and a (meth)acrylic resin is preferably used for the transparent protective film.

The cellulose resin includes an ester of cellulose and a fatty acid. Examples of such a cellulose ester resin include triacetyl cellulose, diacetyl cellulose, tripropionyl cellulose, dipropionyl cellulose, and the like. In particular, triacetyl cellulose is preferred. Triacetyl cellulose has many commercially available sources and is advantageous in view of easy availability and cost. Examples of commercially available products of triacetyl cellulose include UV-50, UV-80, SH-80, TD-80U, TD-TAC, and UZ-TAC (trade names) manufactured by Fujifilm Corporation, and KC series manufactured by Konica Minolta. In general, these triacetyl cellulose products have a thickness direction retardation (Rth) of about 60 nm or less, while having an in-plane retardation (Re) of almost zero.

Cellulose resin films with a relatively small thickness direction retardation may be obtained by processing any of the above cellulose resins. Examples of the processing method include a method that includes laminating a general cellulose-based film to a base film such as a polyethylene terephthalate, polypropylene, or stainless steel film, coated with a solvent such as cyclopentanone or methyl ethyl ketone, drying the laminate by heating (for example, at 80 to 150° C. for about 3 to about 10 minutes) and then separating the base film; and a method that includes coating a general cellulose resin film with a solution of a norbornene resin, a (meth)acrylic resin or the like in a solvent such as cyclopentanone or methyl ethyl ketone, drying the coated film by heating (for example, at 80 to 150° C. for about 3 to about 10 minutes), and then separating the coating.

The cellulose resin film with a relatively small thickness direction retardation to be used may be a fatty acid cellulose resin film with a controlled degree of fat substitution. Triacetyl cellulose for general use has a degree of acetic acid substitution of about 2.8. Preferably, however, the degree of acetic acid substitution is controlled to 1.8 to 2.7, so that the Rth can be reduced. The Rth may also be controlled to be low by adding a plasticizer such as dibutyl phthalate, p-toluenesulfonanilide, or acetyl triethyl citrate, to the fatty acid-substituted cellulose resin. The plasticizer is preferably added in amount of 40 parts by weight or less, more preferably of 1 to 20 parts by weight, even more preferably of 1 to 15 parts by weight, to 100 parts by weight of the fatty acid cellulose resin.

For example, the cyclic polyolefin resin is preferably a norbornene resin. Cyclic olefin resin is a generic name for resins produced by polymerization of cyclic olefin used as a polymerizable unit, and examples thereof include the resins disclosed in JP-A Nos. 01-240517, 03-14882, and 03-122137. Specific examples thereof include ring-opened (co)polymers of cyclic olefins, addition polymers of cyclic olefins, copolymers (typically random copolymers) of cyclic olefins and α-olefins such as ethylene and propylene, graft polymers produced by modification thereof with unsaturated carboxylic acids or derivatives thereof, and hydrides thereof. Examples of the cyclic olefin include norbornene monomers.

Cyclic polyolefin resins have various commercially available sources. Examples thereof include Zeonex (trade name) and Zeonor (trade name) series manufactured by Nippon Zeon Co., Ltd., Arton (trade name) series manufactured by JSR Corporation, Topas (trade name) series manufactured by Ticona, and Apel (trade name) series manufactured by Mitsui Chemicals, Inc.

The (meth)acrylic resin preferably has a glass transition temperature (Tg) of 115° C. or more, more preferably of 120° C. or more, even more preferably of 125° C. or more, particularly preferably of 130° C. or more. If the Tg is 115° C. or more, the resulting polarizing plate can have high durability. The upper limit to the Tg of the (meth)acrylic resin is preferably, but not limited to, 170° C. or less, in view of formability and the like. The (meth)acrylic resin can form a film with an in-plane retardation (Re) of almost zero and a thickness direction retardation (Rth) of almost zero.

Any appropriate (meth)acrylic resin may be used as long as the advantages of the invention are not reduced. Examples of such a (meth)acrylic resin include poly(meth)acrylate such as poly(methyl methacrylate), methyl methacrylate-(meth)acrylic acid copolymers, methyl methacrylate-(meth)acrylate ester copolymers, methyl methacrylate-acrylate ester-(meth)acrylic acid copolymers, methyl (meth)acrylate-styrene copolymers (such as MS resins), and alicyclic hydrocarbon group-containing polymers (such as methyl methacrylate-cyclohexyl methacrylate copolymers and methyl methacrylate-norbornyl (meth)acrylate copolymers). Poly(C₁₋₆ alkyl (meth)acrylate) such as poly(methyl (meth)acrylate) is preferred, and a methyl methacrylate-based resin mainly composed of a methyl methacrylate unit (50 to 100% by weight, preferably 70 to 100% by weight) is more preferred.

Examples of the (meth)acrylic resin include Acrypet VH and Acrypet VRL20A each manufactured by Mitsubishi Rayon Co., Ltd., (meth)acrylic resins having a ring structure in their molecule as disclosed in JP-A No. 2004-70296, and high-Tg (meth)acrylic resins produced by intramolecular crosslinking or intramolecular cyclization reaction.

Lactone ring structure-containing (meth)acrylic resins may also be used, because they have high heat resistance and high transparency and also have high mechanical strength after biaxially stretched.

Examples of the lactone ring structure-containing (meth)acrylic reins include the lactone ring structure-containing (meth)acrylic reins disclosed in JP-A Nos. 2000-230016, 2001-151814, 2002-120326, 2002-254544, and 2005-146084.

The lactone ring structure-containing (meth)acrylic reins preferably have a ring structure represented by formula 1:

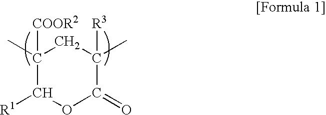

In the formula, R¹, R² and R³ each independently represent a hydrogen atom or an organic residue of 1 to 20 carbon atoms. The organic residue may contain an oxygen atom(s).

The content of the lactone ring structure represented by formula 1 in the lactone ring structure-containing (meth)acrylic resin is preferably from 5 to 90% by weight, more preferably from 10 to 70% by weight, even more preferably from 10 to 60% by weight, particularly preferably from 10 to 50% by weight. If the content of the lactone ring structure represented by formula 1 in the lactone ring structure-containing (meth)acrylic resin is less than 5% by weight, its heat resistance, solvent resistance or surface hardness can be insufficient. If the content of the lactone ring structure represented by formula 1 in the lactone ring structure-containing (meth)acrylic resin is more than 90% by weight, its formability or workability can be poor.

The lactone ring structure-containing (meth)acrylic resin preferably has a mass average molecular weight (also referred to as weight average molecular weight) of 1,000 to 2,000,000, more preferably of 5,000 to 1,000,000, even more preferably of 10,000 to 500,000, particularly preferably of 50,000 to 500,000. Mass average molecular weights outside the above range are not preferred in view of formability or workability.

The lactone ring structure-containing (meth)acrylic resin preferably has a Tg of 115° C. or more, more preferably of 120° C. or more, even more preferably of 125° C. or more, particularly preferably of 130° C. or more. For example, the resin with a Tg of 115° C. or more can produce high durability, when it is incorporated in the form of a transparent protective film in a polarizing plate. The upper limit to the Tg of the lactone ring structure-containing (meth)acrylic resin is preferably, but not limited to, 170° C. or less, in view of formability and the like.

The total light transmittance of the lactone ring structure-containing (meth)acrylic resin, which may be measured according to ASTM-D-1003 with respect to injection molded products, is preferably as high as possible, and specifically, it is preferably 85% or more, more preferably 88% or more, even more preferably 90% or more. The total light transmittance is an index of transparency, and a total light transmittance of less than 85% can result in reduced transparency.

The transparent protective film to be used generally has an in-plane retardation of less than 40 nm and a thickness direction retardation of less than 80 nm. The in-plane retardation Re is expressed by the formula Re=(nx−ny)d, the thickness direction retardation Rth is expressed by the formula Rth=(nx−nz)d, and the Nz coefficient is expressed by the formula Nz=(nx−nz)/(nx−ny), wherein nx, ny and nz are the refractive indices of the film in the directions of its slow axis, fast axis and thickness, respectively, d is the thickness (nm) of the film, and the direction of the slow axis is a direction in which the in-plane refractive index of the film is maximum. Concerning the invention, retardation values were measured at a wavelength of 590 nm with a retardation analyzer (KOBRA 21-ADH (trade name) manufactured by Oji Scientific Instruments) based on the principle of parallel nicols rotation method. The transparent protective film should preferably be as colorless as possible. The transparent protective film to be used preferably has a retardation of −90 nm to +75 nm in its thickness direction. If the transparent protective film used has a retardation (Rth) of −90 nm to +75 nm in the thickness direction, discoloration (optical discoloration) of the polarizing plate, which would otherwise be caused by the transparent protective film, can be almost avoided. The thickness direction retardation (Rth) is more preferably from −80 nm to +60 nm, particularly preferably from −70 nm to +45 nm.

Alternatively, the transparent protective film to be used may be a retardation plate having an in-plane retardation of 40 nm or more and/or a thickness direction retardation of 80 nm or more. The in-plane retardation is generally controlled to be in the range of 40 to 200 nm, and the thickness direction retardation is generally controlled to be in the range of 80 to 300 nm. The retardation plate for use as the transparent protective film also has the function of the transparent protective film and thus can contribute to a reduction in thickness. Alternatively, the retardation plate described later may also be used.

The above-mentioned polarizer and the protective film are usually adhered with aqueous adhesives or the like. As the aqueous adhesives, isocyanate based adhesives, polyvinyl alcohol based adhesives, gelatin based adhesives, vinyl based latex based, aqueous polyurethane based adhesives, aqueous polyester based adhesives, and etc. may be exemplified. Besides the above, the adhesive for bonding the polarizer to the transparent protective film may be an ultraviolet-curable adhesive, an electron beam-curable adhesive or the like.

In an embodiment of the invention, the polarizing plate used as the optical film A preferably has a moisture content of 15% by weight or less, more preferably 0 to 14% by weight, even more preferably 1 to 14% by weight. If the moisture content is more than 15% by weight, the dimensional change of the resulting polarizing plate may significantly increase, and a problem may arise in which the dimensional change may be significant at high temperature or at high temperature and high humidity.

The moisture content of the polarizing plate may be measured by the method described below. A sample (100×100 mm in size) is cut from the polarizing plate, and the initial weight of the sample is measured. The sample is then dried at 120° C. for 2 hours and measured for dry weight.

The moisture content is determined according to the following formula: moisture content (% by weight)={(the initial weight)−(the dry weight)/(the initial weight)}×100. The measurement of each weight is performed three times, and the average value is used.

As the opposite side of the polarizing-adhering surface of the transparent protective film, a film treated with a hard coat layer and various processing aiming for antireflection, sticking prevention and diffusion or anti glare may be used.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles (including beads) comprising cross-linked or non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 40 weight parts. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the transparent protective film itself, and also they may be prepared as an optical layer different from the transparent protective film.

Further an optical film A of the invention may be used as other optical layers, such as a reflective plate, a transflective plate, a retardation plate (a half wavelength plate and a quarter wavelength plate included), and a viewing angle compensation film, a brightness enhancement film, which may be used for formation of a liquid crystal display etc. These are used in practice as an optical film, or as one layer or two layers or more of optical layers laminated with polarizing plate.

Especially preferable polarizing plates are; a reflection type polarizing plate or a transflective type polarizing plate in which a reflective plate or a transflective reflective plate is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

For example, the reflective polarizing plate may have a reflective layer that is formed by providing a foil or evaporated film of a reflective metal such as aluminum on one side of the transparent protective film optionally matte-finished. Alternatively, the transparent protective film may contain fine particles so as to form a fine irregular surface structure, and a reflective layer may be formed thereon so as to have fine irregularities. The reflective layer having fine irregularities has the advantage that incident light can be diffused by irregular reflection so that directivity or glare can be prevented and that uneven light and dark can be reduced. The fine particles-containing transparent protective film also has the advantage that when transmitted therethrough, incident light and reflected light therefrom can be diffused so that uneven light and dark can be further reduced. The reflective layer having fine irregularities corresponding to the fine irregular surface structure of the transparent protective film may be formed by a method including directly providing a metal on the surface of the transparent protective layer by vacuum deposition method, ion plating method, sputtering method, plating method, or any other appropriate method.

Instead of the method of direct deposition on the transparent protective film of the polarizing plate, the reflector may be used in the form of a reflective sheet including an appropriate film according to the transparent film and a reflective layer formed thereon. The reflective layer is generally made of metal. Therefore, the reflective surface thereof is preferably covered with the transparent protective film, the polarizing plate or the like, when used. In order to prevent an oxidation-induced reduction in reflectance so as to keep the initial reflectance for a long time or in order to avoid the formation of an additional protective layer.

In addition, a transflective type polarizing plate may be obtained by preparing the above-mentioned reflective layer as a transflective type reflective layer, such as a half-mirror etc. that reflects and transmits light. A transflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

A description of the above-mentioned elliptically polarizing plate or circularly polarizing plate on which the retardation plate is laminated to the polarizing plates will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without coloring mentioned below by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection.

As retardation plates, birefringence films obtained by uniaxial or biaxial stretching polymer materials, oriented films of liquid crystal polymers, and materials in which orientated layers of liquid crystal polymers are supported with films may be mentioned. Although a thickness of a retardation plate also is not especially limited, it is in general approximately from 20 to 150 μm.

As polymer materials, for example, polyvinyl alcohols, polyvinyl butyrals, polymethyl vinyl ethers, poly hydroxyethyl acrylates, hydroxyethyl celluloses, hydroxypropyl celluloses, methyl celluloses, polycarbonates, polyarylates, polysulfones, polyethylene terephthalates, polyethylene naphthalates, polyethersulfones, polyphenylene sulfides, polyphenylene oxides, polyaryl sulfones, polyamides, polyimides, polyolefins, polyvinyl chlorides, cellulose type polymers, norbornene type resins, bipolymers, terpolymers, graft copolymers, blended materials of the above-mentioned polymers may be mentioned. These polymer raw materials make oriented materials (stretched film) using a stretching process and the like.

As liquid crystalline polymers, for example, various kinds of polymers of principal chain type and side chain type in which conjugated linear atomic groups (mesogens) demonstrating liquid crystalline orientation are introduced into a principal chain and a side chain may be mentioned. As examples of principal chain type liquid crystalline polymers, polymers having a structure where mesogen groups are combined by spacer parts demonstrating flexibility, for example, polyester based liquid crystalline polymers of nematic orientation property, discotic polymers, cholesteric polymers, etc. may be mentioned. As examples of side chain type liquid crystalline polymers, polymers having polysiloxanes, polyacrylates, polymethacrylates, or polymalonates as a principal chain structure, and polymers having mesogen parts comprising para-substituted ring compound units providing nematic orientation property as side chains via spacer parts comprising conjugated atomic groups may be mentioned. These liquid crystalline polymers, for example, are obtained by spreading a solution of a liquid crystal polymer on an orientation treated surface where rubbing treatment was performed to a surface of thin films, such as polyimide and polyvinyl alcohol, formed on a glass plate and or where silicon oxide was deposited by an oblique evaporation method, and then by heat-treating.

A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates are laminated so that optical properties, such as retardation, may be controlled.

The above-mentioned elliptically polarizing plate and an above-mentioned reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such viewing angle compensation retardation plate include a retardation plate, an orientation film of a liquid crystal polymer, or an orientation layer of a liquid crystal polymer supported on a transparent substrate. Ordinary retardation plate is a polymer film having birefringence property that is processed by uniaxially stretching in the plane direction, while the viewing angle compensation retardation plate used is a bidirectional stretched film having birefringence property that is processed by biaxially stretching in the plane direction, or a film, which is controlled the refractive index in the thickness direction, that is processed by uniaxially stretching in the plane direction and is processed by stretching in the thickness direction, and inclined orientation film. As inclined orientation film, for example, a film obtained using a method in which a heat shrinking film is adhered to a polymer film, and then the combined film is heated and stretched or shrunk under a condition of being influenced by a shrinking force, or a film that is oriented in oblique direction may be mentioned. As raw material polymers of the retardation plate, the same polymers the described above is used. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarization light with a predetermined polarization axis, or circularly polarization light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved. If the brightness enhancement film is not used when light from a backlight or the like is incident on the back side of a liquid cell through a polarizer, light whose polarization direction does not coincides with the polarization axis of the polarizer may be almost absorbed (not transmitted) by the polarizer. Therefore, about 50% of the light may be absorbed by the polarizer, depending on the characteristics of the polarizer used, so that the quantity of the light available for image display on a liquid crystal display or the like can be reduced, which may result in a low-brightness image. Light that has a polarization direction such that it can be absorbed by the polarizer is not allowed to enter but temporarily reflected by the brightness enhancement film and then reversed by a reflective layer or the like placed behind the brightness enhancement film and allowed to reenter the brightness enhancement film. During the repetition of this process, the brightness enhancement film can transmit polarized light to the polarizer only when the polarized light reflected and reversed by them has a polarization direction such that it can pass through the polarizer. Therefore, the brightness enhancement film allows efficient use of light from a backlight or the like for image display on a liquid crystal display device and thus allows an increase in the brightness of the screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film; a film that has the characteristics of reflecting a circularly polarized light with either left-handed or right-handed rotation and transmitting other light, such as an aligned film of cholesteric liquid-crystal polymer or a film on which the aligned cholesteric liquid crystal layer is supported; etc. may be mentioned.

Therefore, in the brightness enhancement film of a type that transmits a linearly polarized light having the above-mentioned predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light region, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also in a cholesteric liquid-crystal layer, a layer reflecting a circularly polarized light in a wide wavelength ranges, such as a visible-light region, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate may consist of multi-layered film of laminated layers of a polarizing plate and two of more of optical layers as the above-mentioned separated type polarizing plate. Therefore, a polarizing plate may be a reflection type elliptically polarizing plate or a semi-transmission type elliptically polarizing plate, etc. in which the above-mentioned reflection type polarizing plate or a transflective type polarizing plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing process ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the combined optical film of the invention, for example, the transparent connection film B adhered to at least one side of the combined optical films may be made of the same material as that used to form the transparent protective film for the polarizing plate.

The thickness of the transparent connection film B is generally from about 1 to about 500 μm, in particular, preferably from 5 to 200 μm, in view of strength, workability such as handleability, or thin film-forming capability, while it may be determined as needed.

The transparent connection film B is preferably made of a thermoplastic resin with a water-vapor permeability of 100 g/m² per 24 hours or less. The water-vapor permeability is preferably 60 g/m² per 24 hours or less, more preferably 20 g/m² per 24 hours or less. Particularly in the combined optical film R placed on the backlight BL side of the liquid crystal cell LC as shown in FIG. 5 or 6, the transparent connection film B1 on the backlight BL side is preferably made of a thermoplastic resin with a water-vapor permeability of 100 g/m² per 24 hours or less.

The water-vapor permeability of the transparent connection film may be measured as the gram weight of water vapor passing through a sample with an area of 1 m² for 24 hours at a temperature of 40° C. and a relative humidity of 92%, according to the water-vapor permeability test (cup method) of JIS Z0208.

Examples of such useful thermoplastic resin materials having a water-vapor permeability of 100 g/m² per 24 hours or less include polycarbonate-based polymers, arylate-based polymers, polyester-based polymers such as polyethylene terephthalate and polyethylene naphthalate, amide-based polymers such as nylon and aromatic polyamides, polyolefin-based polymers such as polyethylene, polypropylene, and ethylene-propylene copolymers, cyclo-based or norbornene structure-containing cyclic olefin-based resins, and any mixtures thereof.

Examples thereof also include polymer films as disclosed in JP-A No. 2001-343529 (WO01/37007) and a resin composition that contains (A) a thermoplastic resin having a substituted and/or unsubstituted imide group in the side chain and (B) a thermoplastic resin having a substituted and/or unsubstituted phenyl and nitrile groups in the side chain.

Among these materials, cyclic olefin-based resins are preferred. Cyclic olefin-based resin is a generic name for such resins as those disclosed in JP-A No. Hei03-14882 and Hei03-122137. Specific examples thereof include open-circular polymers of cyclic olefins, addition polymers of cyclic olefins, random copolymers of cyclic olefins and α-olefins such as ethylene and propylene, and graft polymers produced by modification thereof with unsaturated carboxylic acids or derivatives thereof, and hydrides thereof. Examples of cyclic olefins include, but are not limited to, norbornene, tetracyclododecen, and derivatives thereof. Commercially available products thereof include ZEONEX and ZEONOR manufactured by Zeon Corporation, ARTON manufactured by JSR Corporation, and Topas manufactured by Ticona.

The transparent connection film B to be used may have a low retardation at a similar level to that of the transparent protective film. Alternatively, a retardation film may be used as the transparent connection film B.

Various types of pressure-sensitive adhesives may be used to form the pressure-sensitive adhesive layer C, which is used to bond the transparent connection film B to the combined optical films. For example, the pressure-sensitive adhesive to be used may be conveniently selected from materials containing acrylic polymer, silicone-based polymer, polyester, polyurethane, polyamide, polyether, fluoro-based polymer, or rubber-based polymer as a base polymer. In particular, such a material as an acrylic pressure-sensitive adhesive having a high level of optical transparency and weather resistance or heat resistance and exhibiting moderate wettability, cohesive properties and tackiness is preferably used.

Besides the above, the pressure-sensitive adhesive layer preferably has a low coefficient of moisture absorption and high heat resistance, in order to prevent moisture absorption-induced foaming or separation, to prevent optical property degradation due to a thermal expansion difference or the like, to prevent warping of a liquid crystal cell, and to form a liquid crystal display device with high quality and high durability.

The pressure-sensitive adhesive layer may also contain acceptable additives such as fillers comprising natural or synthetic resins, particularly tackifying resins, glass fibers or glass beads, or metal powder, or any other inorganic powder; pigments, coloring agents, and antioxidants. The pressure-sensitive adhesive layer may also contain fine particles so as to have light diffusing ability.

The pressure-sensitive adhesive layer may be formed on the combined optical filmsor on the protective connection film. The process of forming the pressure-sensitive adhesive layer on the combined optical filmsor on the protective connection film may be performed using any appropriate method. Examples of such a method include: a method including the steps of dissolving or dispersing a base polymer or composition thereof in a single body or a mixture of appropriate solvents such as toluene and ethyl acetate to prepare an about 10 to 40% by weight pressure-sensitive adhesive solution and then directly applying the solution to a polarizing plate or an optical film by any appropriate spreading method such as casting method or coating method; and a method including the steps of forming the pressure-sensitive adhesive layer on a separator similarly to the above method and transferring it onto the combined optical films or the protective connection film.

The pressure-sensitive adhesive layer may also be formed as a laminate of layers different in composition, type or the like, on the combined optical films or on the protective connection film. The respective pressure-sensitive adhesive layers may be different in composition, type, thickness, or the like. The thickness of the pressure-sensitive adhesive layer is generally from 1 to 500 μm, preferably from 5 to 200 μm, in particular, preferably from 10 to 100 μm, while it may be determined as needed depending on application purpose, adhering strength, or the like.

A temporary separator is attached to an exposed side of a pressure-sensitive adhesive layer to prevent contamination etc., until it is practically used. Thereby, it can be prevented that foreign matter contacts pressure-sensitive adhesive layer in usual handling. As a separator, without taking the above-mentioned thickness conditions into consideration, for example, suitable conventional sheet materials that are coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

The combined optical film may also have another pressure-sensitive adhesive layer D for bonding the film to any other member such as a liquid crystal cell. The pressure-sensitive adhesive layer D may be formed by the same method with the same material as in the case of the pressure-sensitive adhesive layer C.

As described above, the combined optical film may have an easily-peelable protective film L1.

The protective film L1 is generally formed by placing a pressure-sensitive adhesive layer on a base film so that the base film can be peeled off together with the pressure-sensitive adhesive layer from the optical films, while it may be formed using only a base film.

In an embodiment of the invention, an ultraviolet absorbing capability may be imparted to the optical films or each layer such as the pressure-sensitive adhesive layer, for example, by treatment with an ultraviolet absorbing agent such as a salicylate ester-based compound, a benzophenol-based compound, a benzotriazole-based compound, a cyanoacrylate-based compound, or a nickel-based complex salt compound.

The combined optical film of the invention is preferably used to form various types of image display devices such as liquid crystal displays. Liquid crystal display devices may be formed according to conventional technologies. Specifically, a liquid crystal display device may be typically formed by appropriately assembling a liquid crystal cell, the combined optical film, and optional components such as a lighting system and incorporating a driving circuit, according to conventional technologies with no particular limitation, except that the combined optical film is used according to the invention. The liquid crystal cell to be used may also be of any type such as TN type, STN type, or π type.

Any appropriate liquid crystal display device may be formed such as a liquid crystal display device including a liquid crystal cell and the combined optical film placed one or both sides of the liquid crystal cell and a liquid crystal display using a backlight or a reflector in a lighting system. When the combined optical films are placed on both sides, they may be the same or different. In the process of forming the liquid crystal display, one or more layers of an additional appropriate component(s) such as a diffusion plate, an antiglare layer, an anti-reflection film, a protective plate, a prism array, a lens array sheet, a light diffusion plate, and a backlight may also be placed in an appropriate position(s).

### EXAMPLES

The invention is more specifically described with reference to some examples below, which are not intended to limit the scope of the invention.

The materials described below were used in preparing the combined optical films of the examples and the comparative examples.

Polarizing Plate

A polarizing plate manufactured by Nitto Denko Corporation (TEG5463DUHC) was used. The polarizing plate is composed of a polyvinyl alcohol-based polarizer (25 μm in thickness) and triacetylcellulose films as transparent protective films (each 40 μm in thickness, 80 μm in total) adhered to both sides of the polarizer with a polyvinyl alcohol-based adhesive. One of the transparent protective films is a triacetylcellulose film whose surface is hard-coated. The polarizing plate having the transparent protective films has a thickness of 114 μm and a moisture content of 2.5% by weight.

One end face (long side) of the polarizing plate (100 mm in length, 50 mm in width) was shaped to be parallel to the normal direction of the polarizing plate, before use.

Transparent Connection Films

Z-TAC: A triacetylcellulose base material manufactured by FUJIFILM Corporation (ZRF80S) was used. The base material has a thickness of 80 μm, a water-vapor permeability of 420 g/m², an in-plane retardation (Re) of 0 nm, and a thickness direction retardation (Rth) of 0 nm.

TD-TAC: A triacetylcellulose base material manufactured by FUJIFILM Corporation (TDY-80UL) was used. The base material has a thickness of 80 μm, a water-vapor permeability of 420 g/m², an in-plane retardation (Re) of 5 nm, and a thickness direction retardation (Rth) of 40 nm.

NOR: A product of Zeon Corporation ZEONOR (ZF14-70) was used. The base material has a thickness of 70 μm, a water-vapor permeability of 5 g/m², an in-plane retardation (Re) of 55 nm, and a thickness direction retardation (Rth) of 124 nm.

Pressure-Sensitive Adhesive Layer

An acrylic pressure-sensitive adhesive layer with a dry thickness of 23 μm manufactured by Nitto Denko Corporation was used.

Liquid Crystal Cell and Backlight

Optical films such as polarizing plates and retardation plates were removed from a liquid crystal panel manufactured by Sharp Corporation, AQUOS (LC-26BD1) so that a liquid crystal cell ready for use was obtained. In a similar manner, a backlight ready for use was obtained from the LC-26BDI.

### Example 1

### Preparation of Combined Optical Film

The shaped end faces (vertical end faces) of the polarizing plates were allowed to abut against each other so that the polarizing plates could be combined. The transparent connection film (Z-TAC) was adhered with the pressure-sensitive adhesive to one side of the polarizing plates to be combined, and the transparent connection film (NOR) was adhered with the pressure-sensitive adhesive to the other side of the polarizing plates to be combined, so that a combined optical film was prepared.

Preparation of Liquid Crystal Panel

The resulting combined optical film was adhered with the pressure-sensitive adhesive layer to the lower side (backlight side) of the liquid crystal cell in such a manner that the transparent connection film (Z-TAC) was placed on the liquid crystal cell side. The combined optical film had a gap s with a width t of 2.9 μm between the end faces abutting against each other.

A retardation layer-carrying polarizing plate manufactured by Nitto Denko Corporation (VEGQ1723-X45-270) was adhered to the upper side of the liquid crystal cell. An antiglare-treated triacetylcellulose base material manufactured by FUJIFILM Corporation (TDY-80UL) was further adhered to the upper side of the retardation layer-carrying polarizing plate through the pressure-sensitive adhesive layer. The bonding was performed in such a manner that the absorption axis of the polarizer of the retardation layer-carrying polarizing plate on the upper side made an angle of 90° with that of the polarizer of the polarizing plate on the lower side.

### Example 2

### Preparation of Combined Optical Film

A combined optical film was prepared using the process of Example 1, except that the transparent connection film (TD-TAC) was used in place of the transparent connection film (NOR).

Preparation of Liquid Crystal Panel

A liquid crystal panel was prepared using the process of Example 1, except that the resulting combined optical film was placed on the lower side of the liquid crystal cell. At this time, the combined optical film had a gap s with a width t of 2.7 μm between the end faces of the combined optical films.

### Example 3

### Preparation of Combined Optical Film

A combined optical film was prepared using the process of Example 1, except that the transparent connection film (TD-TAC) was adhered to only one side of the combined polarizing plates.

Preparation of Liquid Crystal Panel

A liquid crystal panel was prepared using the process of Example 1, except that the resulting combined optical film was placed on the lower side of the liquid crystal cell and that the transparent connection film-free side was adhered to the liquid crystal cell with the pressure-sensitive adhesive layer. At this time, the combined optical film had a gap s with a width t of 2.5 μm between the end faces of the combined optical films.

### Comparative Example 1

### Preparation of Combined Optical Film

The shaped end faces (vertical end faces) of the polarizing plates were allowed to abut against each other so that a combined polarizing plate was prepared.

Preparation of Liquid Crystal Panel

The resulting combined optical film was adhered to the lower side of the liquid crystal cell with the pressure-sensitive adhesive layer. At this time, the combined optical film had a gap s with a width t of 2.5 μm between the end faces abutting against each other. The same structure as in Example 1 was formed on the upper side of the liquid crystal cell.

The liquid crystal panel obtained in each of the examples and the comparative example was evaluated as described below. The results are shown in Table 1.

Light Leakage

The liquid crystal panel as shown in Table 1 was placed on the backlight to form a liquid crystal display device. Immediately after the backlight of the liquid crystal display device was turned on, the display device was visually observed from a point 50 cm apart from the top of the viewer side surface of the display, and the presence or absence of light leakage from the connection was determined according to the following criteria: ◯, No light leakage from the connection was visually recognized, when the front was observed; Δ, Light leakage from the connection was slightly visually recognized, when the front was observed; x, Light leakage was clearly visually recognized, when the front was observed.

Durability 1

The liquid crystal panel was stored for 24 hours in a thermostatic chamber (PH-201, manufactured by Espec Corp) kept at 45° C. and then evaluated for light leakage in the same manner. At the same time, the width t of the gap s between the end faces abutting against each other was measured.

TABLE 1

| | Combined polarizing plate | | | | | |
|---|---|---|---|---|---|---|
| | Transparent | | | Evaluations | | |
| | connection | | Transparent | | Durability 1 | |
| | film on the | | connection | | (45° C.) | |
| | liquid | | film on the | Light leakage | Gap | |
| | crystal cell | Gap width | backlight | (immediately | width | Light |
| | side | (μm) | side | after) | (μm) | leakage |
| Example 1 | Z-TAC | 2.9 | NOR | ◯ | 2.9 | ◯ |
| Example 2 | Z-TAC | 2.7 | TD-TAC | ◯ | 2.8 | ◯ |
| Example 3 | Absent | 2.5 | TD-TAC | ◯ | 2.6 | ◯ |
| Comparative | Absent | 2.5 | Absent | ◯ | 20.2 | X |
| Example 1 | | | | | | |

Table 1 shows that the combined optical film of the invention can prevent light leakage over time, which would otherwise be caused by an increase in the gap between the end faces abutting against each other, even when it is used in a liquid crystal display or the like.

### Reference Example 1

### Preparation of Combined Optical Film and Liquid Crystal Panel

A combined optical film and a liquid crystal panel were prepared in the same manner as in Example 1. At this time, the combined optical film had a gap s with a width t of 2.7 μm between the end faces abutting against each other.

### Reference Example 2

### Preparation of Combined Optical Film and Liquid Crystal Panel

A combined optical film and a liquid crystal panel were prepared using the process of Example 1, except that the transparent connection film (NOR) was used in place of the transparent connection film (Z-TAC). The width t of the gap s between the end faces abutting against each other was 2.8 μm.

### Reference Example 3

### Preparation of Combined Optical Film and Liquid Crystal Panel

A combined optical film and a liquid crystal panel were prepared using the process of Example 1, except that the transparent connection film (TD-TAC) was used in place of the transparent connection film (NOR). The width t of the gap s between the end faces abutting against each other was 2.6 μm.

### Reference Example 4

### Preparation of Combined Optical Film and Liquid Crystal Panel

A combined optical film and a liquid crystal panel were prepared using the process of Example 1, except that the transparent connection film (NOR) was used in place of the transparent connection film (Z-TAC) and that the transparent connection film (TD-TAC) was used in place of the transparent connection film (NOR). The width t of the gap s between the end faces abutting against each other was 3.0 μm.

The liquid crystal panel obtained in each of the reference examples was evaluated as described below. The results are shown in Table 2.

Light Leakage

The liquid crystal panel as shown in Table 2 was placed on the backlight to form a liquid crystal display. Immediately after the backlight was turned on, the liquid crystal panel was visually observed from a point 50 cm apart from the top of the viewer side surface, and the presence or absence of light leakage from the connection was determined according to the following criteria: ◯, No light leakage from the connection was visually recognized, when the front was observed; Δ, Light leakage from the connection was slightly visually recognized, when the front was observed; x, Light leakage was clearly visually recognized, when the front was observed.

Durability 2

The liquid crystal panel was stored for 24 hours in a thermostatic chamber (PH-201, manufactured by Espec Corp) kept at 50° C. and then evaluated for light leakage in the same manner. At the same time, the width t of the gap s between the end faces abutting against each other was measured.

TABLE 2

| | Combined polarizing plate | | | Evaluations | | |
|---|---|---|---|---|---|---|
| | | | Transparent | | Durability 2 | |
| | Transparent | | connection | | (50° C.) | |
| | connection | Gap | film on the | Light leakage | Gap | |
| | film on the | width | backlight | (immediately | width | |
| | viewer side | (μm) | side | after) | (μm) | Light leakage |
| Reference | Z-TAC | 2.7 | NOR | ◯ | 2.8 | ◯ |
| Example 1 | | | | | | |
| Reference | NOR | 2.8 | NOR | ◯ | 2.8 | ◯ |
| Example 2 | | | | | | |
| Reference | Z-TAC | 2.6 | TD-TAC | ◯ | 12.3 | Δ |
| Example 3 | | | | | | |
| Reference | NOR | 3.0 | TD-TAC | ◯ | 14.5 | Δ |
| Example 4 | | | | | | |

It is apparent from Table 2 that the combination type optical film of the invention having the protective connection film of low water-vapor permeability on the backlight side gives a good result even in a severe endurance test.

1. A combined optical film, comprising:
a plurality of optical films each having at least one end face, wherein the end faces abut against each other; and
a transparent connection film that is adhered to at least one side of each of the optical films through a pressure-sensitive adhesive layer or an adhesive layer, so that the optical films are joined by the transparent connection film.

2. The combined optical film of claim 1, wherein the optical film comprises a polarizer or a polarizing plate comprising a polarizer and a transparent protective film placed on one or both sides of the polarizer.

3. The combined optical film of claim 1, wherein the transparent connection film on at least one side is made of a thermoplastic resin with a water-vapor permeability of at most 100 g/m² per 24 hours.

4. A liquid crystal panel, comprising:
a liquid crystal cell; and
the combined optical film of claim 1 placed on at least one side of the liquid crystal cell.

5. The liquid crystal panel of claim 4, wherein the optical film in the combined optical film comprises a polarizer or a polarizing plate comprising a polarizer and a transparent protective film placed on one or both sides of the polarizer.

6. The liquid crystal panel of claim 4, wherein the combined optical film is placed on a backlight side of the liquid crystal cell.

7. The liquid crystal panel of claim 6, wherein the combined optical film is placed on the backlight side of the liquid crystal cell in such a manner that the transparent connection film on at least one side is placed on the backlight side.

8. The liquid crystal panel of claim 7, wherein the transparent connection film placed on the backlight side is made of a thermoplastic resin with a water-vapor permeability of at most 100 g/m² per 24 hours.

9. An image display, comprising the combined optical film of claim 1.

10. A liquid crystal display, comprising the liquid crystal panel of claim 4.
